(19) United States
(12) Patent Application Publication
(10) Pub. No.: US 2023/0403452 A1
(43) Pub. Date: Dec. 14, 2023

(54) CAMERA MODULE WITH OPTICAL IMAGE STABILIZATION ACTUATOR

(71) Applicant: SAMSUNG ELECTRO-MECHANICS CO., LTD., Suwon-si (KR)

(72) Inventors: Kyung Hun LEE, Suwon-si (KR); Sung Ho KANG, Suwon-si (KR)

(73) Assignee: SAMSUNG ELECTRO-MECHANICS CO., LTD., Suwon-si (KR)

(21) Appl. No.: 18/109,333

(22) Filed: Feb. 14, 2023

(30) Foreign Application Priority Data
Jun. 10, 2022 (KR) 10-2022-0070577

(51) Int. Cl. H04N 23/55; G02B 27/64; H04N 23/54

(52) U.S. Cl. CPC H04N 23/55; G02B 27/646; H04N 23/54; H04N 23/57

(57) ABSTRACT

An optical image stabilization actuator includes a sensor substrate on which an image sensor having an imaging surface is disposed; a movable frame coupled to the sensor substrate, and movable in a direction parallel to the imaging surface; a fixed frame accommodating the sensor substrate and the movable frame; and a first driving unit disposed on the movable frame and the fixed frame to provide a driving force to the movable frame. The sensor substrate includes a movable part coupled to the movable frame; a fixed part coupled to the fixed frame, and spaced apart from the movable frame in a direction, perpendicular to the imaging surface; and a connection unit connected to the movable part and the fixed part, and the connection unit is connected to the movable part in a direction different from a direction in which the connection unit is connected to the fixed part.

### CROSS-REFERENCE TO RELATED APPLICATIONS

This application claims the benefit under 35 USC § 119(a) of Korean Patent Application No. 10-2022-0070577, filed on Jun. 10, 2022, in the Korean Intellectual Property Office, the entire disclosure of which is incorporated herein by reference for all purposes.

### BACKGROUND

### 1. Field

The following description relates to a camera module with an optical image stabilization actuator.

### 2. Description of Related Art

Camera modules have been implemented in portable electronic devices such as, but not limited to, smartphones, tablet personal computers (PCs), and laptop computers, and actuators which perform focusing and optical image stabilization operations have been provided in such camera modules to generate high-resolution images. For example, the camera module may perform focusing operations by moving a lens module in an optical axis (Z-axis) direction, and may perform optical image stabilization operations by moving the lens module in a direction, perpendicular to the optical axis (Z-axis) direction. However, the weight of the lens module has increased, accordingly, it may be difficult to precisely control a driving force to perform optical image stabilization operations.

### SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

In a general aspect, an optical image stabilization actuator includes a sensor substrate on which an image sensor having an imaging surface is disposed; a movable frame coupled to the sensor substrate, and configured to move in a direction parallel to the imaging surface; a fixed frame configured to accommodate the sensor substrate and the movable frame; and a first driving unit disposed on the movable frame and the fixed frame, and configured to provide a driving force to the movable frame, wherein the sensor substrate includes a movable part coupled to the movable frame; a fixed part coupled to the fixed frame, and spaced apart from the movable frame in a direction, perpendicular to the imaging surface; and a connection part connected to the movable part and the fixed part, wherein the connection part is connected to the movable part in a direction different from a direction in which the connection part is connected to the fixed part.

The connection part may include a first support connected to the fixed part in the direction parallel to the imaging surface; a second support connected to the movable part in the direction perpendicular to the imaging surface; and a plurality of bridges, each having a length in the direction parallel to the imaging surface, and configured to connect the first support and the second support to each other.

The first support may be spaced apart from the movable part, and the second support is spaced apart from the fixed part.

The first support and the second support may be made of a rigid material, and the plurality of bridges are made of a flexible material.

The direction parallel to the imaging surface may include a first axis direction and a second axis direction, perpendicular to each other, and the second support may be configured to have a longer length than a length of the first support in at least one of the first axis direction and the second axis direction.

The second support may include a first pad disposed on a surface that faces the movable part in the direction perpendicular to the imaging surface, and the movable part may include a second pad on any one surface thereof parallel to the imaging surface.

The actuator may include a conductive adhesive layer disposed between the movable part and the second support.

The movable part may include an opening that penetrates therethrough in the direction perpendicular to the imaging surface to expose the first pad.

The direction parallel to the imaging surface may include a first axis direction and a second axis direction, perpendicular to each other, and the movable part may be configured to have a shorter length than a length of the fixed part in at least one of the first axis direction and the second axis direction.

The actuator may include a first ball member disposed between the movable frame and the fixed frame, and configured to support a movement of the movable frame; and a plurality of magnetic bodies disposed on the movable frame and the fixed frame respectively, and configured to generate an attractive force in the direction perpendicular to the imaging surface.

The first driving unit may include a first driving magnet and a second driving magnet disposed on the movable frame; and a first driving coil and a second driving coil disposed on the fixed frame, and configured to face the first driving magnet and the second driving magnet, respectively, wherein the plurality of magnetic bodies disposed on the movable frame may be the first driving magnet and the second driving magnet.

The plurality of magnetic bodies disposed on the fixed frame may be a plurality of pulling yokes, and the plurality of pulling yokes may be disposed to face the first driving magnet and the second driving magnet.

In a general aspect, an actuator includes a movable part comprising an image sensor having an imaging surface, and configured to move in a direction parallel to the imaging surface; a fixed part spaced apart from the movable part in a direction perpendicular to the imaging surface; a plurality of supports each connected to one of the fixed part and the movable part; and a plurality of bridges configured to support a movement of the movable part, and configured to connect the plurality of supports to each other.

The plurality of supports may include a first support connected to the fixed part; and a second support connected to the movable part, wherein the movable part and the second support are electrically connected to each other.

The direction parallel to the imaging surface may include a first axis direction and a second axis direction, perpendicular to each other, and wherein the movable part may have a shorter length than a length of the fixed part in at least one of the first axis direction and the second axis direction.

In a general aspect, a camera module includes a sensor substrate on which an image sensor is disposed; a fixed frame; and a movable frame, disposed on the fixed frame; wherein the sensor substrate comprises: a fixed printed circuit board (PCB), coupled to a lower surface of the fixed frame; a movable PCB, on which the image sensor is mounted, and configured to move together with the movable frame in a direction perpendicular to an optical axis direction; and a connection part configured to connect the fixed PCB and the movable PCB to each other; wherein the movable PCB is configured to overlap the fixed PCB in the optical axis direction.

The movable PCB may be configured to have a shorter length in at least one of a first axis direction and a second axis direction perpendicular to the optical axis direction when compared to the fixed PCB.

The connection part may include a first support configured to connect the connection part to the fixed PCB, and a second support configured to connect the connection part to the movable PCB.

Other features and aspects will be apparent from the following detailed description, the drawings, and the claims.

### BRIEF DESCRIPTION OF DRAWINGS

FIG. 1 illustrates a perspective view of an example camera module, in accordance with one or more embodiments.

FIG. 2 illustrates a schematic exploded perspective view of an example camera module, in accordance with one or more embodiments.

FIG. 3 illustrates a perspective view of an example first actuator, in accordance with one or more embodiments.

FIG. 4 illustrates a schematic exploded perspective view of an example first actuator, in accordance with one or more embodiments.

FIG. 5 illustrates a schematic exploded perspective view of an example first driving unit, in accordance with one or more embodiments.

FIG. 6A illustrates a cross-sectional view taken along line I-I′ of FIG. 3

FIG. 6B illustrates an enlarged view of part A of FIG. 6A.

FIG. 7A illustrates a cross-sectional view taken along line II-II′ of FIG. 3.

FIG. 7B illustrates an enlarged view of part B of FIG. 7A.

FIG. 8 illustrates a view illustrating a movable frame, in accordance with one or more embodiments.

FIG. 9 illustrates an exploded perspective view of an example sensor substrate, in accordance with one or more embodiments.

FIG. 10A illustrates a plan view of FIG. 9, in accordance with one or more embodiments.

FIGS. 10B and 10C illustrate side views of FIG. 9, in accordance with one or more embodiments.

FIG. 11A illustrates an enlarged view of part C of FIG. 10B, in accordance with one or more embodiments.

FIG. 11B is a view illustrating part C of FIG. 10B, in accordance with one or more embodiments.

FIG. 12 illustrates perspective views of an example movable frame and an example sensor substrate, in accordance with one or more embodiments.

FIG. 13 is a view illustrating a state in which an example movable frame and an example sensor substrate are coupled to each, in accordance with one or more embodiments.

FIG. 14A illustrates a plan view of an example sensor substrate, in accordance with one or more embodiments.

FIGS. 14B and 14C illustrate side views of FIG. 14A, in accordance with one or more embodiments.

FIG. 15A illustrates a plan view of an example sensor substrate, in accordance with one or more embodiments.

FIGS. 15B and 15C illustrate side views of FIG. 15A, in accordance with one or more embodiments.

FIG. 16 illustrates a perspective view of an example second actuator, in accordance with one or more embodiments.

FIG. 17 illustrates a schematic exploded perspective view of an example second actuator, in accordance with one or more embodiments.

FIG. 18 illustrates a side view of an example carrier, in accordance with one or more embodiments.

FIG. 19 illustrates a perspective view of an example housing, in accordance with one or more embodiments.

FIG. 20 illustrates a cross-sectional view taken along line III-III′ of FIG. 16.

Throughout the drawings and the detailed description, the same reference numerals may refer to the same, or like, elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known, after an understanding of the disclosure of this application, may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. Likewise, expressions, for example, “between” and “immediately between” and “adjacent to” and “immediately adjacent to” may also be construed as described in the foregoing.

The terminology used herein is for the purpose of describing particular examples only, and is not to be used to limit the disclosure. As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof. The use of the term “may” herein with respect to an example or embodiment (for example, as to what an example or embodiment may include or implement) means that at least one example or embodiment exists where such a feature is included or implemented, while all examples are not limited thereto.

Unless otherwise defined, all terms, including technical and scientific terms, used herein have the same meaning as commonly understood by one of ordinary skill in the art to which this disclosure pertains consistent with and after an understanding of the present disclosure. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

One or more examples may provide an optical image stabilization actuator that improves an optical image stabilization operation, and a camera module including the optical image stabilization actuator.

One or more examples may also provide a camera module having a size that is reduced in at least one dimension.

An optical image stabilization actuator and a camera module including the optical image stabilization actuator, in accordance with one or more embodiments, may be mounted on a portable electronic device. In a non-limiting example, the portable electronic device may be a mobile communication terminal, a smart phone, a tablet PC, or similar devices.

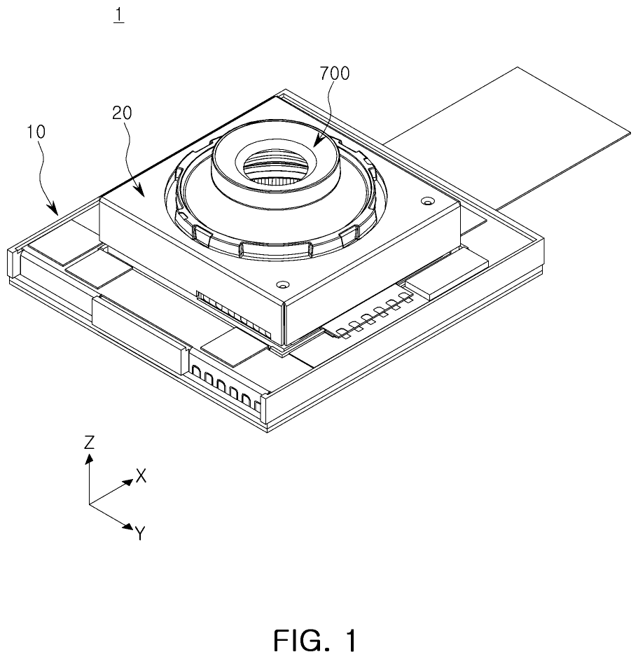

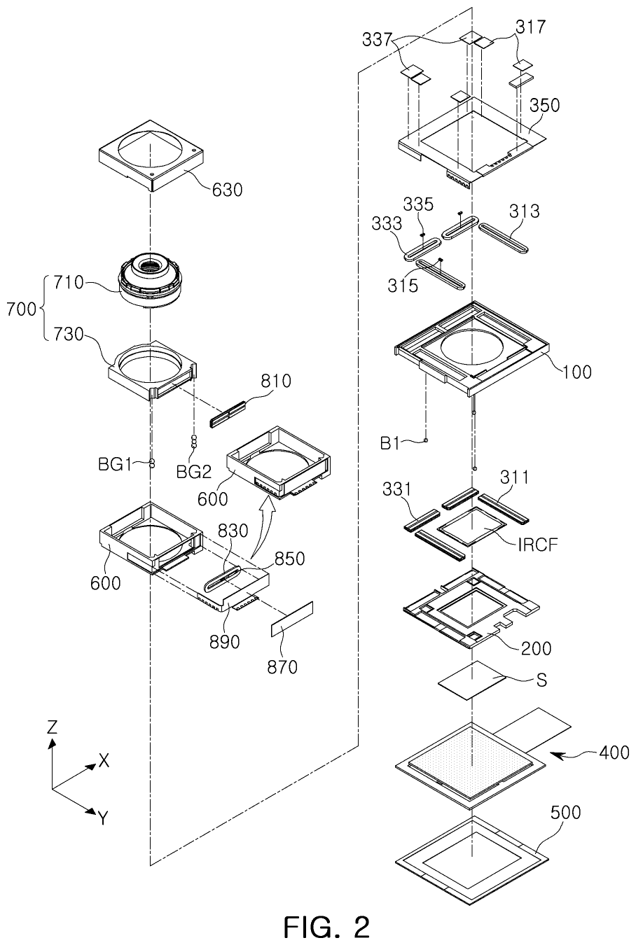

FIG. 1 illustrates a perspective view of an example camera module, in accordance with one or more embodiments, and FIG. 2 illustrates a schematic exploded perspective view of an example camera module, in accordance with one or more embodiments.

Referring to FIGS. 1 and 2, an example camera module 1, in accordance with one or more embodiments, may include a lens module 700, an image sensor S, a first actuator 10, and a second actuator 20.

In an example, the first actuator 10 may be an actuator to perform an optical image stabilization operation, and the second actuator 20 may be an actuator to perform a focusing operation.

In an example, the lens module 700 may include at least one lens and a lens barrel 710. At least one lens may be disposed in the lens barrel 710. When two or more lenses are disposed in the lens module 700, the lenses may be disposed along an optical axis (Z-axis) direction.

Referring to FIG. 2, in an example, the lens module 700 may further include a carrier 730 coupled to the lens barrel 710. A hollow portion that penetrates through the carrier 730 in the optical axis (Z-axis) direction may be provided in the carrier 730, and the lens barrel 710 may be fixedly coupled to the carrier 730 while being inserted into the hollow portion.

In an example, the lens module 700 may be a movable member that moves in the optical axis (Z-axis) direction during a focusing operation. In an example, the focusing operation may be performed by the second actuator 20. That is, the lens module 700 may be moved in the optical axis (Z-axis) direction by the second actuator 20 during a focusing operation.

On the other hand, the lens module 700 may be a fixed member that does not move during optical image stabilization.

In an example, the camera module 1 may perform optical image stabilization by moving the image sensor S instead of moving the lens module 700. In an example where the image sensor S, which may have a lighter weight than a weight of the lens module 700, is moved to perform optical image stabilization, less driving force may be needed during optical image stabilization, thereby achieving optical image stabilization in a more precise manner.

In an example, optical image stabilization may be performed by the first actuator 10. In an example, the image sensor S may be moved in a direction, perpendicular to the optical axis (Z-axis) by the first actuator 10, or may be rotated about the optical axis (Z-axis) as a rotation axis to perform optical image stabilization.

In one or more examples, a direction that an imaging surface of the image sensor S faces may be referred to as the optical axis (Z-axis) direction. That is, in the drawings illustrating the one or more examples, the image sensor S moving in a direction parallel to the imaging surface may be understood as the image sensor S moving in a direction, perpendicular to the optical axis (Z-axis).

Additionally, in the one or more examples, the direction, perpendicular to the optical axis (Z-axis) may be a first axis (X-axis) direction and a second axis (Y-axis) direction, and the image sensor S moving in the first axis (X-axis) direction and in the second axis (Y-axis) direction may be understood as the image sensor S moving in the direction, perpendicular to the optical axis (Z-axis).

Additionally, in the one or more examples, the first axis (X-axis) direction and the second axis (Y-axis) direction may be understood as two directions intersecting each other while being perpendicular to the optical axis (Z-axis).

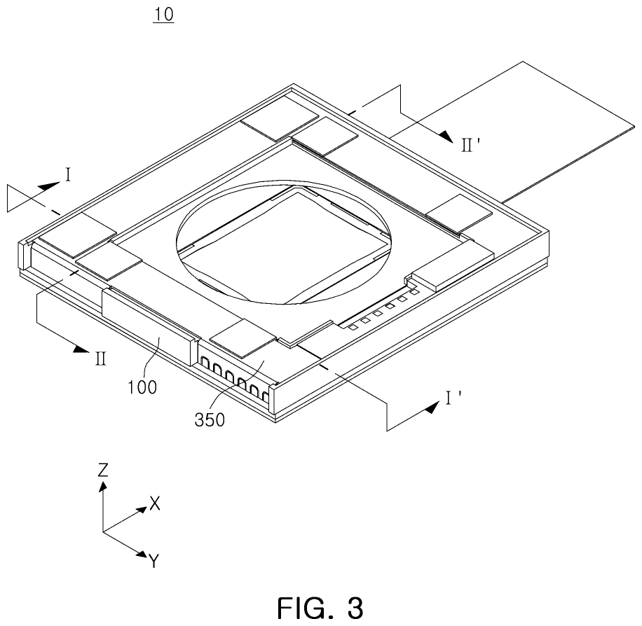

Hereinafter, an optical image stabilization operation of the camera module 1, in accordance with one or more embodiments, will be described with reference to FIGS. 3 through 15.

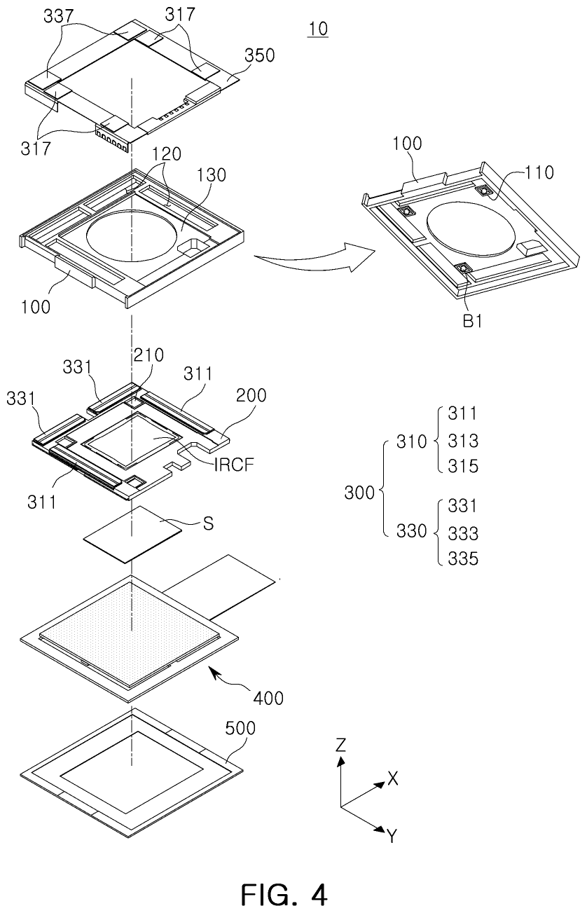

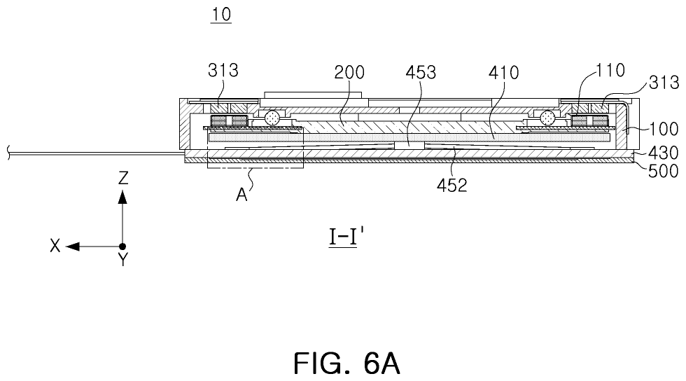

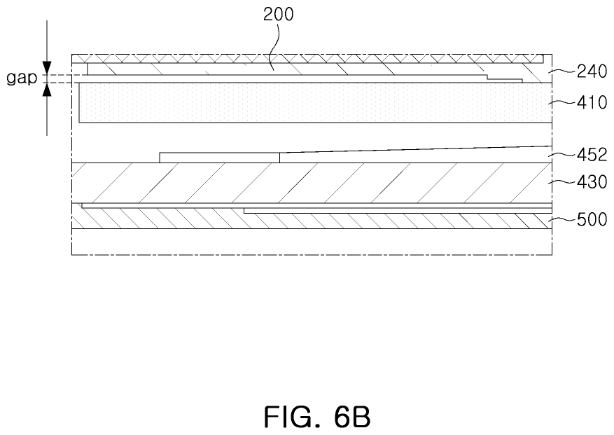

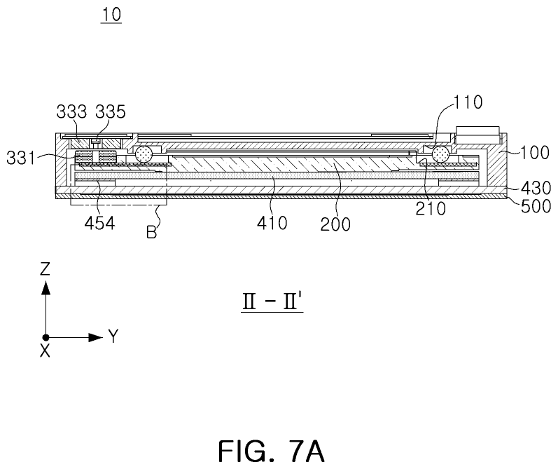

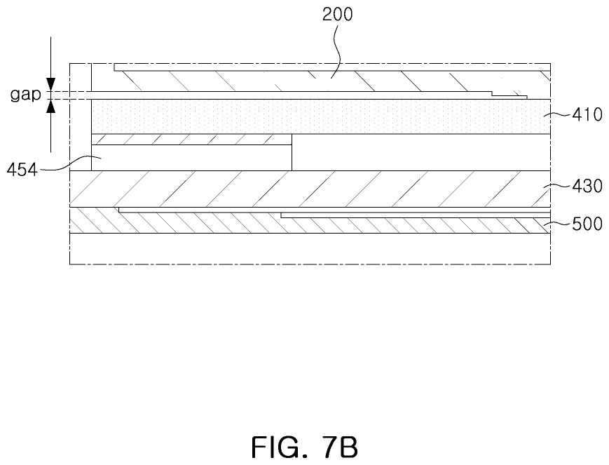

FIG. 3 illustrates a perspective view of the first actuator 10, in accordance with one or more embodiments, and FIG. 4 illustrates a schematic exploded perspective view of the first actuator 10, in accordance with one or more embodiments. Additionally, FIG. 6A illustrates a cross-sectional view taken along line I-I′ of FIG. 3, FIG. 6B is an enlarged view of part A of FIG. 6A, FIG. 7A is a cross-sectional view taken along line II-II′ of FIG. 3, and FIG. 7B is an enlarged view of part B of FIG. 7A.

Referring to FIG. 4, the first actuator 10, in accordance with one or more embodiments, may include a fixed frame 100, a movable frame 200, a first driving unit 300, and a sensor substrate 400, and may further include a base 500.

In an example, the fixed frame 100 may have a rectangular box shape with upper and lower sides thereof being open. The fixed frame 100 may be coupled to the second actuator 20. The fixed frame 100 may be coupled to a housing 600 of the second actuator 20. In an example, the housing 600 may be seated on an upper surface of the fixed frame 100 based on the optical axis (Z-axis) direction, and a seating groove 130 may be formed in the upper surface of the fixed frame 100 to seat the housing 600 therein.

In an example, the fixed frame 100 may be a fixed member that does not move during focusing operations and during optical image stabilization operations.

In an example, the movable frame 200 may be accommodated in the fixed frame 100. In an example, the movable frame 200 may be seated on a lower surface of the fixed frame 100 in the optical axis (Z-axis) direction, and an accommodating space may be formed in the lower surface of the fixed frame 100 to accommodate the movable frame 200 therein. In an example, a sidewall extending in the optical axis (Z-axis direction) may be formed on the lower surface of the fixed frame 100 to form an accommodation space in which the movable frame 200 is accommodated.

In an example, the movable frame 200 may be a movable member that is moved during optical image stabilization. For example, during optical image stabilization, the movable frame 200 may be moved relative to the fixed frame 100 in the first axis (X-axis) direction, and the second axis (Y-axis) direction, perpendicular to the optical axis (Z-axis), or may be rotated about the optical axis (Z-axis) as a rotation axis. Although in the one or more examples the movable frame 200 may be moved in the first axis (X-axis) direction and the second axis (Y-axis) direction, perpendicular to the optical axis (Z-axis), the direction in which the movable frame 200 actually moves may not coincide with the first axis (X-axis) direction or the second axis (Y-axis) direction.

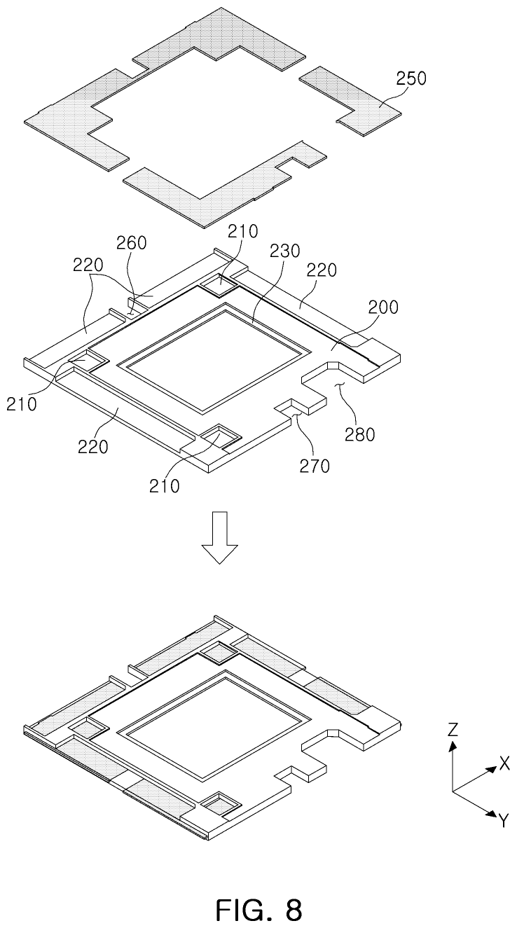

In an example, the movable frame 200 may have a rectangular plate shape with a central portion thereof being perforated in the optical axis (Z-axis) direction. Additionally, an infrared cut filter (IRCF) may be mounted on an upper surface of the perforated central portion of the movable frame 200, and the sensor substrate 400 may be mounted on a lower surface of the perforated central portion of the movable frame 200. Additionally, as illustrated in FIG. 8, a mounting groove 230 may be provided in the upper surface of the perforated central portion of the movable frame 200 to mount the infrared cut filter (IRCF) therein.

In an example, since the movable frame 200 is accommodated in or on the fixed frame 100, a thickness of the movable frame 200 may be reduced in order to reduce a height of the first actuator 10 in the optical axis (Z-axis) direction. However, when the thickness of the movable frame 200 is reduced, the rigidity of the movable frame 200 may be weakened, resulting in a deterioration in reliability against external impact.

Therefore, in an example, the movable frame 200 may include a reinforcing plate 250 to reinforce the rigidity of the movable frame 200. In an example, the reinforcing plate 250 may be formed of stainless steel.

FIG. 8 is a view illustrating the movable frame 200, in accordance with one or more embodiments.

Referring to FIG. 8, the reinforcing plate 250 may be integrally coupled to the movable frame 200 by an insert injection process. In this example, the reinforcing plate 250 and the movable frame 200 may be manufactured integrally by injecting a resin material in a state where the reinforcing plate 250 is fixed in a mold.

In an example, the reinforcing plate 250 may be disposed inside the movable frame 200, and at the same time, a partial portion of the reinforcing plate 250 may be disposed to be exposed to the outside of the movable frame 200. As the reinforcing plate 250 is partially exposed to the outside of the movable frame 200 while being integrally formed with the movable frame 200, a coupling force between the reinforcing plate 250 and the movable frame 200 can be improved, and the reinforcing plate 250 can be prevented from being decoupled from the movable frame 200.

In an example, the image sensor S may be mounted on the sensor substrate 400. Additionally, a partial portion of the sensor substrate 400 may be coupled to the movable frame 200, and another portion may be coupled to the fixed frame 100.

Specifically, the image sensor S may be mounted on the partial portion of the sensor substrate 400 coupled to the movable frame 200. Since the partial portion of the sensor substrate 400 may be coupled to the movable frame 200, when the movable frame 200 is moved or rotated, the partial portion of the sensor substrate 400 may also be moved or rotated together with the movable frame 200. Accordingly, the image sensor S may be moved or rotated on a plane perpendicular to the optical axis (Z-axis) for optical image stabilization during the capture of an image.

In an example, the first driving unit 300 may generate a driving force in a direction, perpendicular to the optical axis (Z-axis) to move the movable frame 200 in the direction, perpendicular to the optical axis (Z-axis), or to rotate the movable frame 200 about the optical axis (Z-axis) as a rotation axis.

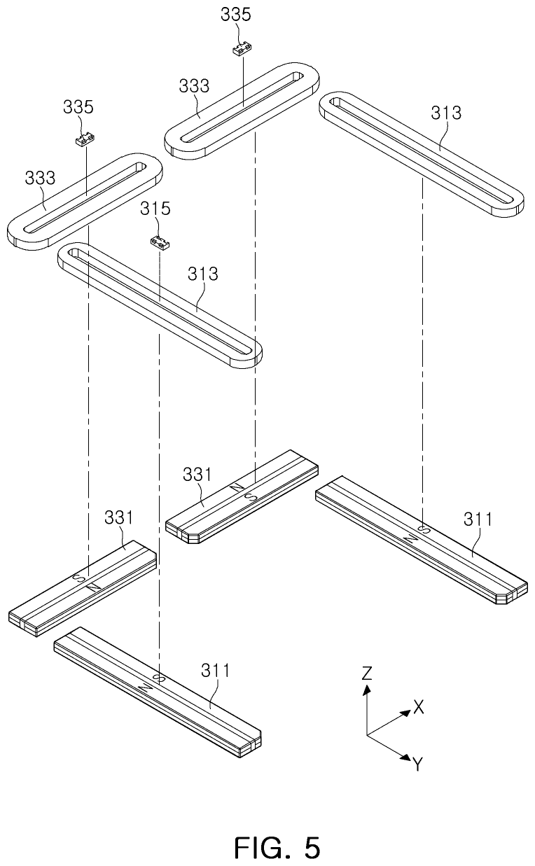

FIG. 5 is a schematic exploded perspective view of the first driving unit 300, in accordance with one or more embodiments.

Referring to FIG. 5, the first driving unit 300, in accordance with one or more embodiments, may include a first sub driving unit 310 (311, 313, 315) and a second sub driving unit 330 (331, 333, 335). The first sub driving unit 310 may generate a driving force in the first axis (X-axis) direction, and the second sub driving unit 330 may generate a driving force in the second axis (Y-axis) direction.

In an example, the first sub driving unit 310 may include a first driving magnet 311 and a first driving coil 313. The first driving magnet 311 and the first driving coil 313 may be disposed to face each other in the optical axis (Z-axis) direction.

In an example, the first driving magnet 311 may be disposed on the movable frame 200. Referring to FIG. 8, a mounting groove 220 may be provided in an upper surface of the movable frame 200 in the optical axis (Z-axis) direction to dispose the first driving magnet 311 therein. Since the first driving magnet 311 may be inserted into the mounting groove 220 of the movable frame 200, it is possible to prevent the thickness of the first driving magnet 311 from causing an increase in height of the first actuator 10 and an increase in overall height of the camera module 1 in the optical axis (Z-axis) direction.

In a non-limiting example, the first driving magnet 311 may include a plurality of magnets. In an example, the first driving magnet 311 may include two magnets spaced apart from each other in a direction in which the driving force is generated by the first driving magnet 311, that is, in the first axis (X-axis) direction, while being symmetric with respect to the optical axis (Z-axis).

Referring to FIG. 5, the first driving magnet 311 may have a length in the second axis (Y-axis) direction. Additionally, the first driving magnet 311 may be magnetized so that one surface thereof, e.g., a surface thereof facing the first driving coil 313 has both an N-pole and an S-pole. For example, a first surface of the first driving magnet 311 facing the first driving coil 313 may be magnetized to have an N-pole, a neutral region, and an S-pole sequentially disposed in the first axis (X-axis) direction. A second surface of the first driving magnet 311 may also be magnetized to have both an S-pole and an N-pole. For example, the second surface of the first driving magnet 311 may be magnetized to have an S-pole, a neutral region, and an N-pole sequentially disposed in the first axis (X-axis) direction.

In an example, the first driving coil 313 may be mounted on a first substrate 350, and may be disposed on the fixed frame 100. Referring to FIG. 4, a through-hole 120 may be formed in the upper surface of the fixed frame 100 in the optical axis (Z-axis) direction. The through-hole 120 may be formed to penetrate through the upper surface of the fixed frame 100 in the optical axis (Z-axis) direction. The first driving coil 313 may be disposed in the through-hole 120 of the fixed frame 100. Since the first driving coil 313 may be disposed in the through-hole 120 of the fixed frame 100, it is possible to prevent the thickness of the first driving coil 313 from causing an increase in height of the first actuator 10, and an increase in overall height of the camera module 1 in the optical axis (Z-axis) direction.

In an example, the first driving coil 313 may include a plurality of coils. For example, the first driving coil 313 may include two coils that correspond to the number of magnets included in the first driving magnet 311, and the two coils may be spaced apart from each other in the first axis (X-axis) direction while being symmetric with respect to the optical axis (Z-axis). Additionally, the first driving coil 313 may have a length in the second axis (Y-axis) direction.

In an example, when power is applied to the first driving coil 313, the movable frame 200 may be moved in the first axis (X-axis) direction, perpendicular to the optical axis (Z-axis) direction, in which the first driving magnet 311 and the first driving coil 313 face each other, due to an electromagnetic force between the first driving magnet 311 and the first driving coil 313. Referring to FIG. 6A, the movable frame 200 may be moved in the first axis (X-axis) direction by a driving force in the first axis (X-axis) direction.

In an example, the first driving magnet 311 may be a movable member mounted on the movable frame 200 to move together with the movable frame 200, and the first driving coil 313 may be a fixed member fixed to the first substrate 350 and the fixed frame 100.

In an example, the second sub driving unit 330 may include a second driving magnet 331 and a second driving coil 333. The second driving magnet 331 and the second driving coil 333 may be disposed to face each other in the optical axis (Z-axis) direction.

In an example, the second driving magnet 331 may be disposed in the movable frame 200. Referring to FIG. 8, a mounting groove 220 may be provided in the upper surface of the movable frame 200 based on the optical axis (Z-axis) direction to dispose the second driving magnet 331 therein. Since the second driving magnet 331 is inserted into the mounting groove 220 of the movable frame 200, it is possible to prevent the thickness of the second driving magnet 331 from causing an increase in height of the first actuator 10 and an increase in overall height of the camera module 1 in the optical axis (Z-axis) direction.

In an example, the second driving magnet 331 may include a plurality of magnets. For example, the second driving magnet 331 may include two magnets spaced apart from each other in the first axis (X-axis) direction, perpendicular to a direction in which the driving force is generated by the second driving magnet 331, that is, the second axis (Y-axis) direction.

However, in an example, the first driving magnet 311 and the second driving magnet 331 may be arranged reversely. For example, the first driving magnet 311 may include two magnets spaced apart from each other in the second axis (Y-axis) direction, perpendicular to the first axis (X-axis) direction, in which the driving force is generated by the first driving magnet 311, and the second driving magnet 331 may include two magnets spaced apart from each other in the second axis (Y-axis) direction, in which the driving force is generated by the second driving magnet 331.

Alternatively, as another example, each of the first driving magnet 311 and the second driving magnet 331 may include two magnets spaced apart from each other in a direction, perpendicular to a direction in which the driving force is generated thereby.

Referring to FIG. 5, the second driving magnet 331 may have a length in the first axis (X-axis) direction. Additionally, the second driving magnet 331 may be magnetized so that one surface thereof, e.g., a surface thereof facing the second driving coil 333 has both an S-pole and an N-pole. For example, a first surface of the second driving magnet 331 facing the second driving coil 333 may be magnetized to have an S-pole, a neutral region, and an N-pole sequentially disposed in the second axis (Y-axis) direction. A second surface of the second driving magnet 331 may also be magnetized to have both an N-pole and an S-pole. For example, the second surface of the second driving magnet 331 may be magnetized to have an N-pole, a neutral region, and an S-pole sequentially disposed in the second axis (Y-axis) direction.

In an example, the second driving coil 333 may be mounted on the first substrate 350, and may be disposed on the fixed frame 100. Referring to FIG. 4, a through-hole 120 may be formed in the upper surface of the fixed frame 100 in the optical axis (Z-axis) direction. The through-hole 120 may be formed to penetrate through the upper surface of the fixed frame 100 in the optical axis (Z-axis) direction. The second driving coil 333 may be disposed in the through-hole 120 of the fixed frame 100. Since the second driving coil 333 may be disposed in the through-hole 120 of the fixed frame 100, it is possible to prevent the thickness of the second driving coil 333 from causing an increase in height of the first actuator 10 and an increase in overall height of the camera module 1 in the optical axis (Z-axis) direction.

In an example, the second driving coil 333 may include a plurality of coils. In a non-limited example, the second driving coil 333 may include two coils to correspond to the number of magnets included in the second driving magnet 331, and the two coils may be spaced apart from each other in the first axis (X-axis) direction. Additionally, in an example, the second driving coil 333 may have a length in the second axis (Y-axis) direction.

In an example, when power is applied to the second driving coil 333, the movable frame 200 may be moved in the second axis (Y-axis) direction, perpendicular to the optical axis (Z-axis) direction, in which the second driving magnet 331 and the second driving coil 333 face each other, due to the interaction of an electromagnetic force between the second driving magnet 331 and the second driving coil 333. Referring to FIG. 7A, the movable frame 200 may be moved in the second axis (Y-axis) direction based on the driving force in the second axis (Y-axis) direction.

In an example, the second driving magnet 331 may be a movable member mounted on the movable frame 200 to move together with the movable frame 200, and the second driving coil 333 may be a fixed member that is fixed to the first substrate 350 and the fixed frame 100.

Additionally, in an example, the first sub driving unit 310 and the second sub driving unit 330 may rotate the movable frame 200 about the optical axis (Z-axis). For example, the movable frame 200 may be rotated about the optical axis (Z-axis) by intentionally generating a deviation between a magnitude of the driving force in the first axis (X-axis) direction and a magnitude of the driving force in the second axis (Y-axis) direction.

In an example, referring to FIG. 4, a first ball member B1 may be disposed between the fixed frame 100 and the movable frame 200.

The first ball member B1 may include a plurality of ball members. The first ball member B1 may be disposed to contact each of the fixed frame 100 and the movable frame 200. When the movable frame 200 is moved or rotated relative to the fixed frame 100, the first ball member B1 may roll between the fixed frame 100 and the movable frame 200 to guide the movement of the movable frame 200. At the same time, the first ball member B1 may also maintain a gap between the fixed frame 100 and the movable frame 200.

Specifically, when a driving force is generated in the first axis (X-axis) direction, the first ball member B1 may roll in the first axis (X-axis) direction to guide a movement of the movable frame 200 in the first axis (X-axis) direction.

Additionally, when a driving force is generated in the second axis (Y-axis) direction, the first ball member B1 may roll in the second axis (Y-axis) direction to guide a movement of the movable frame 200 in the second axis (Y-axis) direction.

Referring to FIG. 4, the fixed frame 100 and the movable frame 200 may include guide grooves in their respective surfaces which face each other in the optical axis (Z-axis) direction to dispose the first ball member B1 therein. The number of guide grooves provided in each of the fixed frame 100 and the movable frame 200 may correspond to the number of a plurality of ball members of the first ball member B1.

For example, a first guide groove 110 may be formed in the lower surface of the fixed frame 100 in the optical axis (Z-axis) direction, and a second guide groove 210 may be formed in the upper surface of the movable frame 200 in the optical axis (Z-axis) direction. The first ball member B1 may be disposed between the fixed frame 100 and the movable frame 200 while being accommodated in both the first guide groove 110 and the second guide groove 210.

In an example, the first guide groove 110 and the second guide groove 210 may be formed to have a size larger than a diameter of the first ball member B1. Accordingly, the first ball member B1 may roll in a direction, perpendicular to the optical axis (Z-axis) while being accommodated in the first guide groove 110 and the second guide groove 210, and the rolling direction is not limited to a specific direction.

Referring to FIGS. 6B and 7B, in an example, the movable frame 200 may include a protrusion 240. The protrusion 240 may be a portion of the movable frame 200 that protrudes toward the sensor substrate 400. The protrusion 240 of the movable frame 200 may be coupled to a movable part 410 of the sensor substrate 400, which will be described below. Accordingly, a gap may be formed between the movable frame 200 and the sensor substrate 400 in the optical axis (Z-axis) direction, and the sensor substrate 400 may not be affected by a movement and a rotation of the movable frame 200.

However, the position of the protrusion 240 described above is merely an example, and the protrusion 240 may be formed at another position as long as the protrusion 240 forms a gap in the optical axis (Z-axis) direction between the movable frame 200 and the sensor substrate 400.

In an example, the first actuator 10 may detect a position of the movable frame 200 in a direction, perpendicular to the optical axis (Z-axis). Accordingly, the first actuator 10 may include a first position sensor 315 and a second position sensor 335.

Referring to FIG. 5, the first position sensor 315 may be disposed on the first substrate 350 to face the first driving magnet 311, and the second position sensor 335 may be disposed on the first substrate 350 to face the second driving magnet 331. Additionally, the first position sensor 315 and the second position sensor 335 may be hall sensors.

In an example, as illustrated in FIG. 5, the second position sensor 335 may include two hall sensors. For example, the second driving magnet 331 may include two magnets that are spaced apart from each other in the first axis (X-axis) direction, and the second position sensor 335 may include two hall sensors disposed to face the two magnets, respectively. By including two hall sensors, the second position sensor 335 may detect whether or not the movable frame 200 is rotated.

In an example, the first actuator 10 may include a plurality of magnetic bodies that form an attractive force in the optical axis (Z-axis) direction between the fixed frame 100 and the movable frame 200 to prevent the first ball member B1 from escaping or from being dislodged.

For example, referring to FIG. 4, the fixed frame 100 may include a first pulling yoke 317 and a second pulling yoke 337. In other words, the plurality of magnetic bodies disposed in the fixed frame 100 may be the first pulling yoke 317 and the second pulling yoke 337.

The first pulling yoke 317 and the second pulling yoke 337 may be mounted on the first substrate 350 and may be disposed on the fixed frame 100. For example, the first driving coil 313 and the second driving coil 333 may be disposed on one surface of the first substrate 350, and the first pulling yoke 317 and the second pulling yoke 337 may be disposed on the other surface of the first substrate 350.

In an example, the first pulling yoke 317 and the second pulling yoke 337 may be disposed to face the first driving magnet 311 and the second driving magnet 331 disposed on the movable frame 200, respectively, in the optical axis (Z-axis) direction. That is, the plurality of magnetic bodies disposed in the movable frame 200 may be the first driving magnet 311 and the second driving magnet 313.

Additionally, each of the first pulling yoke 317 and the second pulling yoke 337 may include a plurality of pulling yokes. Accordingly, each of the first driving magnet 311 and the second driving magnet 331 may face the plurality of pulling yokes in the optical axis (Z-axis) direction.

Additionally, the first pulling yoke 317 and the second pulling yoke 337 may be formed of a material that generates an attractive force with the first driving magnet 311 and the second driving magnet 331.

In an example, since the attractive force acts in the optical axis (Z-axis) direction between the first pulling yoke 317 and the first driving magnet 311 and between the second pulling yoke 337 and the second driving magnet 331, the first ball member B1 may be maintained in contact with the fixed frame 100 and the movable frame 200.

Additionally, in an example, as the attractive force acts in the optical axis (Z-axis) direction between the first pulling yoke 317 and the first driving magnet 311 and between the second pulling yoke 337 and the second driving magnet 331, the movable part 410 of the sensor substrate 400 may be in a lifted state in the optical axis (Z-axis) direction with respect to a fixed part 430, which will be described below.

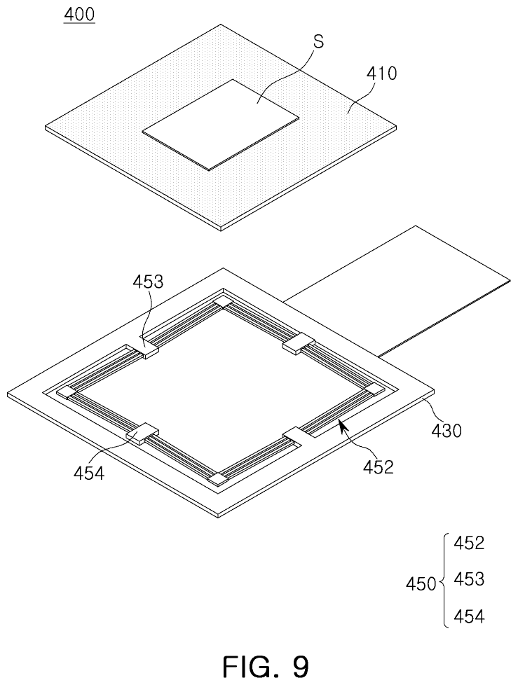

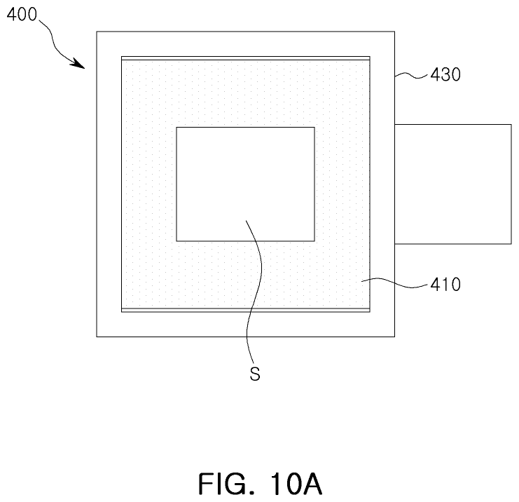

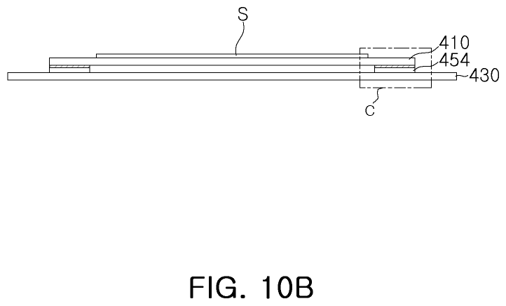

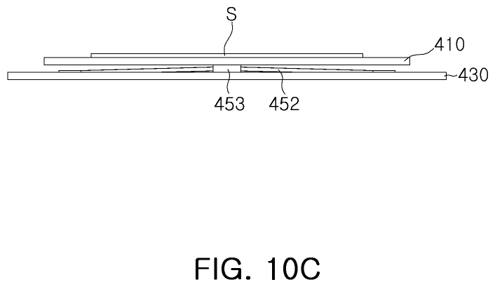

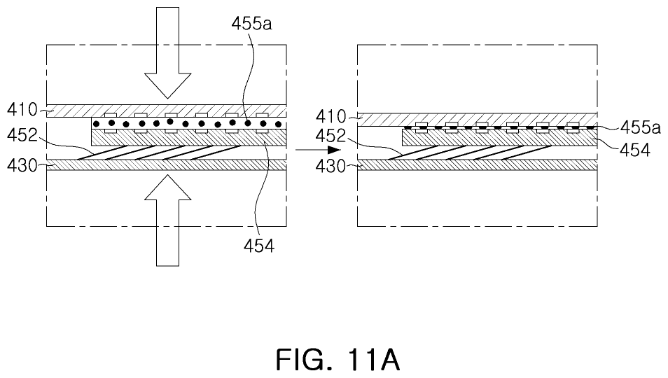

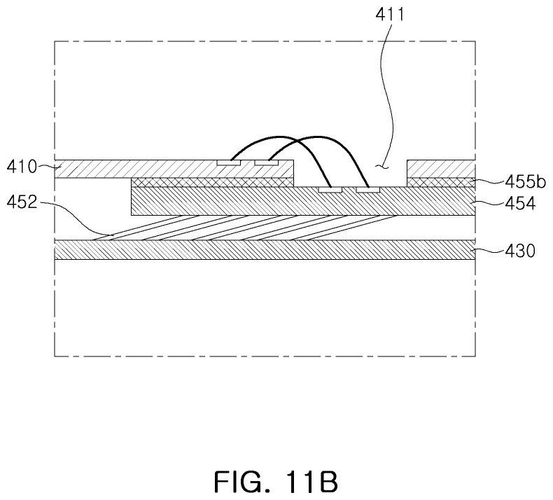

FIG. 9 is an exploded perspective view of the sensor substrate, in accordance with one or more embodiments, FIG. 10A is a plan view of FIG. 9, FIGS. 10B and 100 are side views of FIG. 9, and FIGS. 11A and 11B are enlarged views of part C of FIG. 10B, in accordance with one or more embodiments.

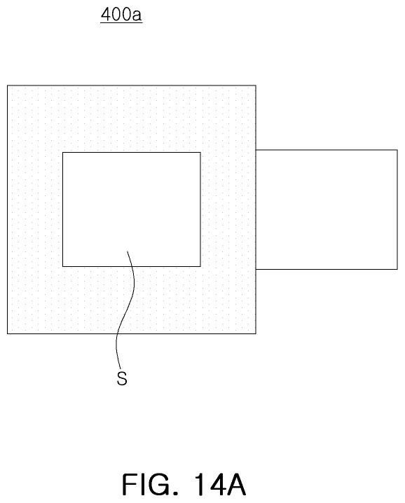

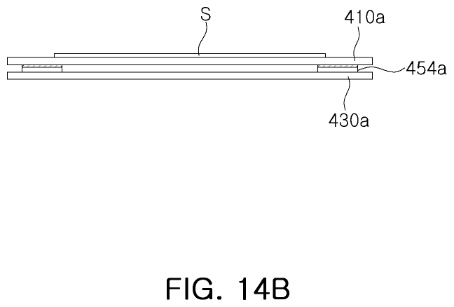

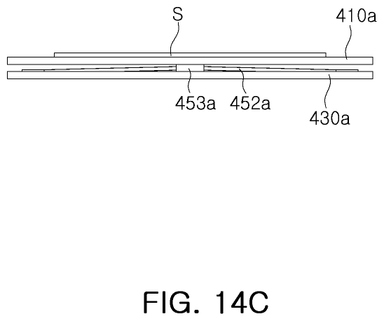

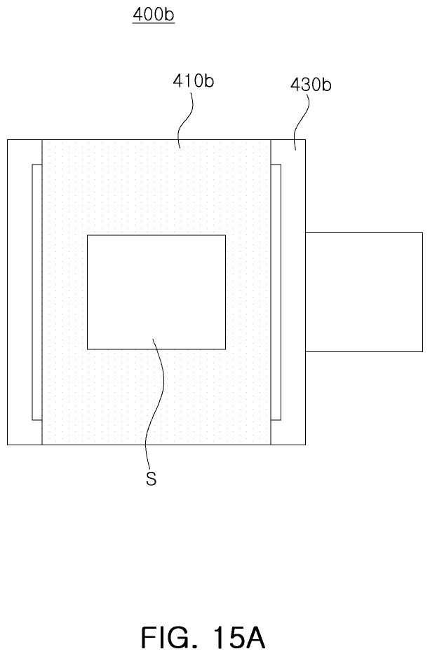

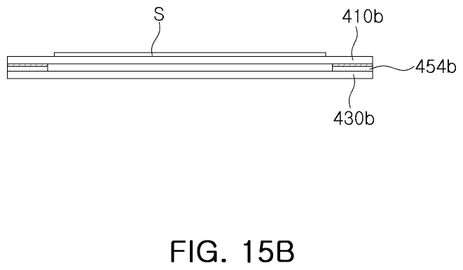

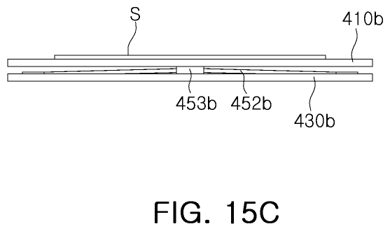

FIG. 14A is a plan view of a sensor substrate, in accordance with one or more embodiments, FIGS. 14B and 14C are side views of FIG. 14A, FIG. 15A is a plan view of a sensor substrate, in accordance with one or more embodiments, and FIGS. 15B and 15C are side views of FIG. 15A.

In an example, the sensor substrate 400 may include a movable part 410, a fixed part 430, and a connection part 450 (FIG. 9). Additionally, the sensor substrate 400 may be a rigid flexible printed circuit board (RF PCB).

In an example, the image sensor S may be mounted on the movable part 410, and, in an example, the movable part 410 may be a rigid printed circuit board (rigid PCB).

In an example, the movable part 410 may be a movable member moving together with the movable frame 200 during optical image stabilization. For example, the movable part 410 may be coupled to a lower surface of the movable frame 200. Specifically, the image sensor S may be mounted on a central portion of the movable part 410, and a portion on which the image sensor S is not mounted, that is, a peripheral portion of the movable part 410 may be coupled to the lower surface of the movable frame 200.

In an example, the fixed part 430 may be a rigid printed circuit board (rigid PCB). Additionally, the fixed part 430 may be a fixed member that does not move during optical image stabilization. For example, the fixed part 430 may be coupled to the lower surface of the fixed frame 100.

Also, the fixed part 430 may include a hollow portion that penetrates therethrough in the optical axis (Z-axis) direction, and the movable part 410 may be disposed to overlap the hollow portion of the fixed part 430.

In an example, the connection part 450 (452, 453, 454) (FIG. 9) may structurally and electrically connect the movable part 410 and the fixed part 430 to each other.

In an example, the connection part 450 may include a rigid printed circuit board (rigid PCB) and a flexible printed circuit board (flexible PCB). By including a flexible printed circuit board formed of a bendable material, the connection part 450 may support a movement of the movable part 410.

Additionally, the connection part 450 may include a plurality of slits, and may include a plurality of bridges 452 with gaps in the first axis (X-axis) direction or the second axis (Y-axis) direction, perpendicular to the optical axis (Z-axis) according to the plurality of slits. The plurality of bridges 452 may have a length in the first axis (X-axis) direction or in the second axis (Y-axis) direction, and may be formed along an inner perimeter of the fixed part 430.

In an example, the movable part 410 and the fixed part 430 may be disposed in the optical axis (Z-axis) direction with respect to each other. Additionally, a gap may be formed between the movable part 410 and the fixed part 430. As a result, the movable part 410 may not be affected by the fixed part 430 during movement.

Additionally, in an example, the connection part 450 may be disposed on substantially the same plane as the fixed part 430 when viewed in the optical axis (Z-axis) direction. For example, the connection part 450 and the fixed part 430 may be spaced apart from each other in the first axis (X-axis) and the second axis (Y-axis) direction, perpendicular to the optical axis (Z-axis) direction. In this example, the connection part 450 may be disposed to be closer to the optical axis (Z-axis) than the fixed part 430. Accordingly, the connection part 450 may be disposed in the optical axis (Z-axis) direction with respect to the movable part 410.

In the example camera module 1, since the movable part 410 and the fixed part 430 of the sensor substrate 400 are disposed in the optical axis (Z-axis) direction with respect to each other, a length of the camera module 1 in at least one of the first axis (X-axis) direction and the second axis (Y-axis) direction can be reduced as compared with that in an example where the movable part 410 and the fixed part 430 are disposed in a direction, perpendicular to the optical axis (Z-axis) with respect to each other.

In an example, as illustrated in FIGS. 10A through 100, the movable part 410 may have shorter lengths in the first axis (X-axis) direction and the second axis (Y-axis) direction, perpendicular to the optical axis (Z-axis) than the fixed part 430.

In an example, as illustrated in FIGS. 14A through 14C, a movable part 410a may have a same length in the first axis (X-axis) direction and the second axis (Y-axis) direction, perpendicular to the optical axis (Z-axis) as a fixed part 430a. In an example, a movable part 410b may have a shorter length in one of the first axis (X-axis) direction and the second axis (Y-axis) direction, perpendicular to the optical axis (Z-axis) than a fixed part 430b. Specifically, referring to FIGS. 15A through 15C, the length of the movable part 410b in the first axis (X-axis) direction may be shorter than the length of the fixed part 430b, and the length of the movable part 410b in the second axis (Y-axis) direction may be the same as the length of the fixed part 430b.

The examples presented above are advantageous in reducing the size of camera module 1, because the length of the camera module 1 in at least one of the first axis (X-axis) direction and the second axis (Y-axis) direction, perpendicular to the optical axis (Z-axis) can be reduced as compared with an example where the movable parts 410, 410a, and 410b and the fixed parts 430, 430a, and 430b are spaced apart from each other in a direction, perpendicular to the optical axis (Z-axis).

Hereinafter, structures of the movable part 410, the fixed part 430, and the connection part 450 will be described based on an example illustrated in FIGS. 9 through 10C. The following description may be identically applied to other examples illustrated in FIGS. 14A through 14C and in FIGS. 15A through 15C.

In an example, the connection part 450 may be connected to the movable part 410 and the fixed part 430, and the movable part 410 and the fixed part 430 may be connected to each other through the connection part 450. Specifically, the movable part 410 and the fixed part 430 may be structurally and electrically connected to each other through the connection part 450.

In an example, the connection part 450 may include a first support 453 and a second support 454. For example, the first support 453 may be connected to the fixed part 430, and the second support 454 may be connected to the movable part 410. Additionally, the first support 453 may be spaced apart from the movable part 410, and the second support 454 may be spaced apart from the fixed part 430.

Referring to FIG. 9, the first support 453 may include two support members spaced apart from each other in the second axis (Y-axis) direction and two support members 454 spaced apart from each other in the first axis (X-axis) direction. The first support 453 may have a length in the second axis (Y-axis) direction. The first support 453 may connect the fixed part 430 and a portion of the connection part 450 spaced apart from each other in the second axis (Y-axis) direction, while each having a length in the first axis (X-axis) direction, to each other. The first support 453 may be disposed at a longitudinal central portion of the connection part 450 connected to the fixed part 430 by the first support 453.

One side of the first support 453 may contact the fixed part 430, and the other side of the first support 453 may contact the connection part 450. As an example, the first support 453 may be a component extending from the fixed part 430.

The second support 454 may include two support members spaced apart from each other in the first axis (X-axis) direction. The second support 454 may have a length in the first axis (X-axis) direction. At a portion of the connection part 450 having a length in the second axis (Y-axis) direction, the second support 454 may connect the connection part 450 and the movable part 410 spaced apart from each other in the optical axis (Z-axis) direction to each other. The second support 454 may be disposed at a longitudinal central portion of the connection part 450 connected to the movable part 410 by the second support 454.

The movable part 410 may be coupled to one surface of the second support 454. Referring to FIGS. 11A and 11B, the movable part 410 may be coupled to one surface of the second support 454 through an adhesive layer.

Then, the movable part 410 may be electrically connected to the second support 454, and accordingly, may be electrically connected to the fixed part 430. This will be described in detail below.

Meanwhile, the second support 454 may have a gap with the fixed part 430 in a direction, perpendicular to the optical axis (Z-axis). As an example, the second support 454 may be integrally formed with the fixed part 430, and may be cut to have a gap with the fixed part 430 in a subsequent process. Accordingly, when the movable part 410 moves, the second support 454 may not be affected by the fixed part 430 while supporting the movement of the movable part 410.

In an example, the movable part 410 and the fixed part 430 may be spaced apart from each other in the optical axis (Z-axis) direction, and the movable part 410 may be in a further lifted state in the optical axis (Z-axis) direction with respect to the fixed part 430 due to an attractive force acting in the optical axis (Z-axis) direction between the movable frame 200 and the fixed frame 100.

Specifically, the movable part 410 may be supported at a lifted position in the optical axis (Z-axis) direction with respect to the fixed frame 100 by the plurality of bridges 452 connected to the second support 454. Due to the attractive force acting in the optical axis (Z-axis) direction between the movable frame 200 and the fixed frame 100, a portion of each of the plurality of bridges 452 connected to the second support 454 may be lifted in the optical axis (Z-axis) direction. When the sensor substrate 400 is viewed focused on a portion where the second support 454 is formed, each of the plurality of bridges 452 may have a height in the optical axis (Z-axis) direction that gradually decreases from a central portion connected to the second support 454 toward an edge thereof.

In an example, through the structure described above, the movable part 410 may be moved in a direction, perpendicular to the optical axis (Z-axis) or may be rotated about the optical axis (Z-axis), while being supported by the connection part 450.

For example, when the movable part 410 and the image sensor S are moved in the first axis (X-axis) direction, the plurality of bridges 452 connected to the second support 454 may be bent. Additionally, when the movable part 410 and the image sensor S are moved in the second axis (Y-axis) direction, the plurality of bridges 452 connected to the first support 453 may be bent. Furthermore, when the movable part 410 and the image sensor S are rotated about the optical axis (Z-axis), the plurality of bridges 452 connected to the first support 453 and the second support 454 may be bent.

Meanwhile, although it has been described in the one or more examples that the two support members of the first support 453 are spaced apart from each other in the second axis (Y-axis) direction, and the two support members of the second support 454 are spaced apart from each other in the first axis (X-axis) direction, these are only examples, and the positions of the first support 453 and the second support 454 may be reversed.

In an example, the movable part 410 may be electrically connected to the second support 454, and accordingly, may be electrically connected to the fixed part 430.

In an example, referring to FIG. 11A, the movable part 410 and the second support 454 may be structurally and electrically connected to each other through an adhesive layer, more particularly, a conductive adhesive layer 455a.

The conductive adhesive layer 455a may be disposed between the movable part 410 and the second support 454 in the optical axis (Z-axis) direction. Specifically, the movable part 410 and the second support 454 may include pads for electrical connection on their surfaces facing each other (hereinafter, the pad provided in the second support 454 will be referred to as a first pad, and the pad provided in the movable part 410 will be referred to as a second pad), and the conductive adhesive layer 455a may be disposed between a portion where the first pad of the second support 454 is formed and a portion where the second pad of the movable part 410 is formed.

The conductive adhesive layer 455a may be a layer having adhesiveness and conductivity. For example, the conductive adhesive layer 455a may be an anisotropic conductive film (ACF) in which conductive balls are mixed in an insulating member. Such an anisotropic conductive film may have conductivity when the conductive balls are broken and the insulating film is destroyed by applying heat and/or pressure thereto. However, the conductive adhesive layer 455a is not limited to the anisotropic conductive film, and may be an anisotropic conductive paste, a solution containing conductive particles, or the like.

Referring to FIG. 11A, the conductive adhesive layer 455a may have conductivity by applying heat and/or pressure thereto. In an example, pressure may be applied in the optical axis (Z-axis) direction so that the conductive adhesive layer 455a has conductivity, and accordingly, the conductive adhesive layer 455a may have conductivity in the optical axis (Z-axis) direction. On the other hand, the conductive adhesive layer 455a may not have conductivity in the first axis (X-axis) direction and the second axis (Y-axis) direction, perpendicular to the optical axis (Z-axis).

In an example, referring to FIG. 11B, the movable part 410 and the second support 454 may be structurally connected to each other through an adhesive layer 455b and electrically connected to each other through wire bonding.

The movable part 410 may include an opening 411 that exposes a partial portion of the second support 454 for wire bonding. Specifically, the second support 454 and the movable part 410 may include a first pad and a second pad, respectively, to enable electrical connection on upper surfaces thereof based on the optical axis (Z-axis) direction, and the first pad provided in the second support 454 may be exposed through the opening 411 of the movable part 410.

In an example illustrated in FIG. 11B, the movable part 410 and the second support 454 may be electrically connected to each other without fixation that necessitates high temperature and high pressure.

In an example, as the movable part 410 and the second support 454 are electrically connected to each other, a signal of the image sensor S may be transmitted to the fixed part 430.

Meanwhile, although it is illustrated in the drawings that the first support 453 and the second support 454 have the same length and width, this is only an example, and the length and width of the first support 453 and the second support 454 may be changed if necessary.

In an example, since the second support 454 and the movable part 410 may be disposed in the optical axis (Z-axis) direction with respect to each other, the second support 454 may further include a component to electrically connect the movable part 410 to the connection part 450 and the fixed part 430. Accordingly, the length and width of the second support 454 may be changed.

For example, the second support 454 may have a longer length in at least one of a length direction and a width direction than the first support 453. Based on the drawings, the second support 454 being formed to be long in the length direction may mean that one side of the second support 454 extends toward the central portion of the movable part 410, on which the image sensor S is disposed. Additionally, the second support 454 being formed to be long in the width direction may mean that the second support 454 extends in the length direction of each of the plurality of bridges 452 connected to the second support 454. Accordingly, in an example where the second support 454 extends in the width direction, a length of each of the plurality of bridges 452 may be relatively short.

In an example, the base 500 may be coupled to a lower portion of the sensor substrate 400.

The base 500 may be coupled to the sensor substrate 400 to cover the lower portion of the sensor substrate 400. In an example, the base 500 may prevent foreign substances from entering a gap between the movable part 410 and the fixed part 430.

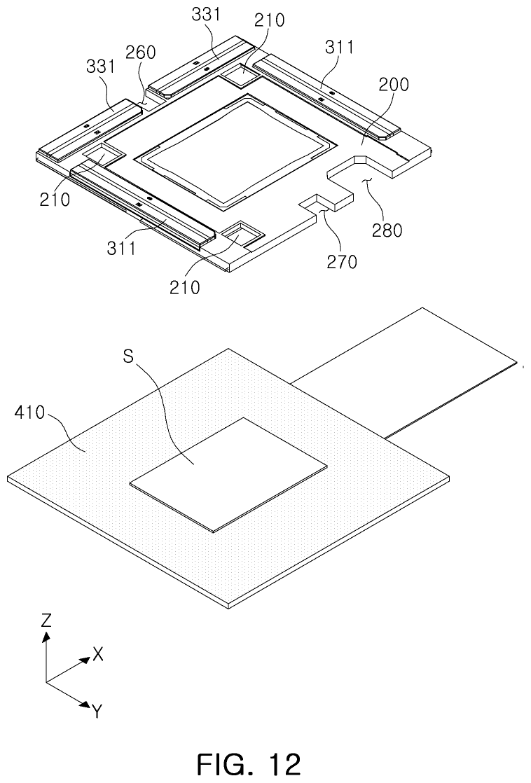

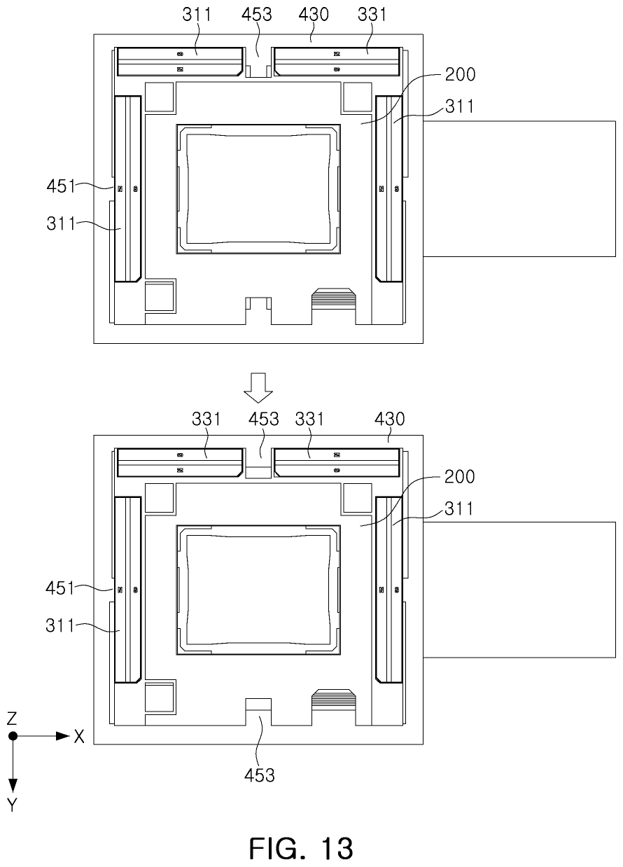

FIG. 12 illustrates perspective views of the movable frame and the sensor substrate, in accordance with one or more embodiments, and FIG. 13 is a view illustrating a state in which the movable frame and the sensor substrate are coupled to each other, in accordance with one or more embodiments.

Referring to FIGS. 12 and 13, a first escape hole 260 and a second escape hole 270 may be formed in the movable frame 200. In an example, the first escape hole 260 and the second escape hole 270 may be components penetrating through the movable frame 200 in the optical axis (Z-axis) direction.

In an example, in a state where the movable frame 200 and the sensor substrate 400 are coupled to each other, each of the first escape hole 260 and the second escape hole 270 may overlap a partial portion of the fixed part 430 and a space between the fixed part 430 and the connection part 450 of the sensor substrate 400 in the optical axis (Z-axis) direction. That is, when the movable frame 200 is viewed in the optical axis (Z-axis) direction, a partial portion of the fixed part 430 and a space between the fixed part 430 and the connection part 450 may be exposed through each of the first escape hole 260 and the second escape hole 270.

Meanwhile, as described above, the connection part 450 of the sensor substrate 400 may include a first support 453 and a second support 454. Additionally, the connection part 450 may be connected to the fixed part 430 through the first support 453, and may be connected to the movable part 410 through the second support 454.

That is, since the first support 453 may be spaced apart from the movable part 410, and the second support 454 may be spaced apart from the fixed part 430, the plurality of bridges 452 of the connection part 450 may support the movable part 410 in a flexible state.

Meanwhile, if the sensor substrate 400 and the movable frame 200 are coupled to each other in a state where the plurality of bridges 452 of the connection part 450 have flexibility, there is a problem that it may be difficult to fix the position of the movable part 410 supported by the connection part 450 in the coupling process. Additionally, this is highly likely to lead to assembly failure, and thus, it may be beneficial that the plurality of bridges 452 of the connection part 450 do not have flexibility at the time of coupling the sensor substrate 400 and the movable frame 200 to each other.

Accordingly, in an example, the movable frame 200 and the sensor substrate 400 may be coupled to each other in a state where any one of the first support 453 and the second support 454 is connected to all of the movable part 410, the fixed part 430, and the plurality of bridges 452.

In an example, referring to FIG. 13, the first support 453 may be connected to the fixed part 430 but spaced apart from the movable part 410, and the second support 454 may be connected to all of the movable part 410, the fixed part 430, and the plurality of bridges 452. In this state, the plurality of bridges 452 may not have flexibility.

In an example, once the movable part 410 of the sensor substrate 400 and the movable frame 200 are coupled to each other, portions where the second support 454 and the fixed part 430 are coupled to each other may be exposed through the first escape hole 260 and the second escape hole 270. Therefore, the portions where the second support 454 and the fixed part 430 are coupled to each other may be cut through the first escape hole 260 and the second escape hole 270, and the movable part 410 of the sensor substrate 400 may have flexibility after coupled to the movable frame 200.

In another example, as illustrated in FIGS. 14A through 14C, in an example where the movable part 410a and the fixed part 430a are formed to have the same lengths in the first axis (X-axis) direction and the second axis (Y-axis) direction, perpendicular to the optical axis (Z-axis), portions where the second support 454a and the fixed part 430a are coupled to each other may not be exposed through the first escape hole 260 and the second escape hole 270.

Therefore, in this example, after the movable part 410a of the sensor substrate 400a and the movable frame 200 are coupled to each other, a process of cutting a connected portion between the second support 454a and the fixed part 430a from a rear surface of the fixed part 430a may be performed.

Additionally, in this example, the movable frame 200 may not include a first escape hole 260 and a second escape hole 270.

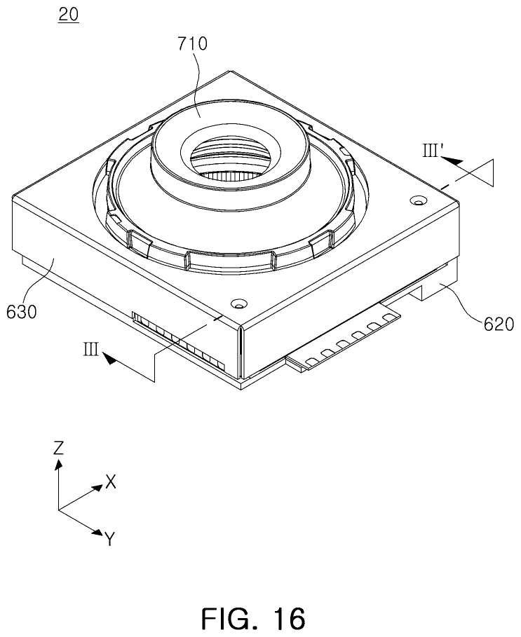

Hereinafter, a focusing operation of the example camera module 1, in accordance with one or more embodiments, will be described with reference to FIGS. 16 through 20.

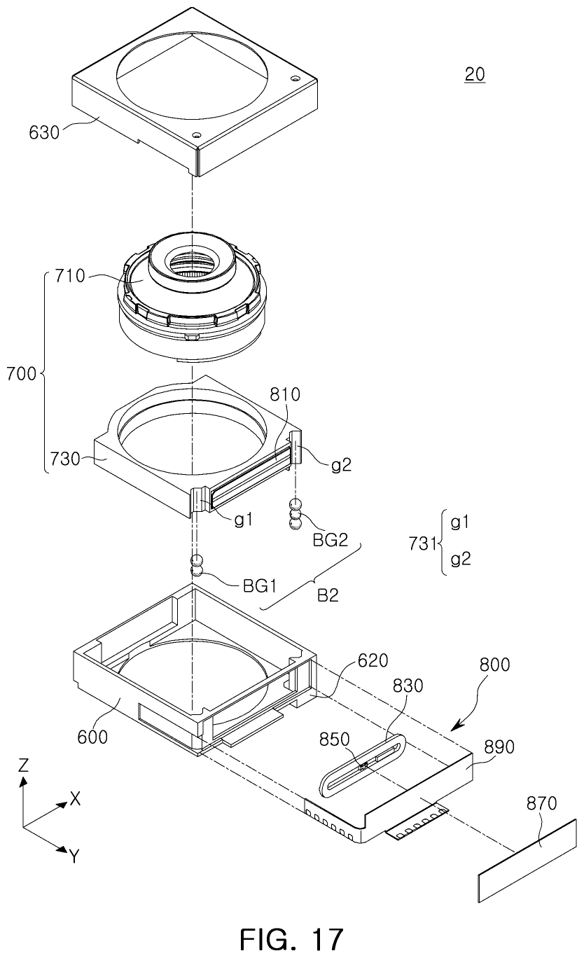

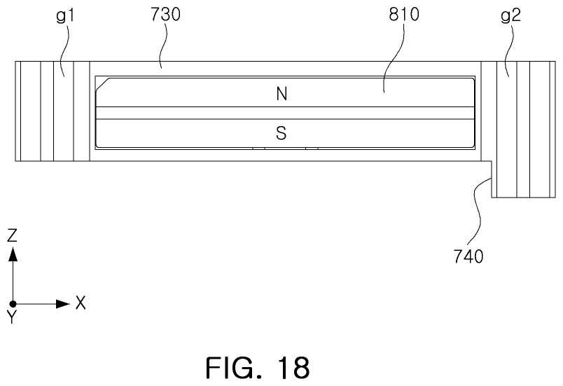

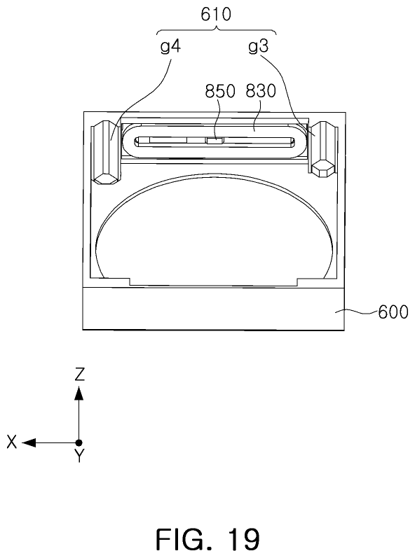

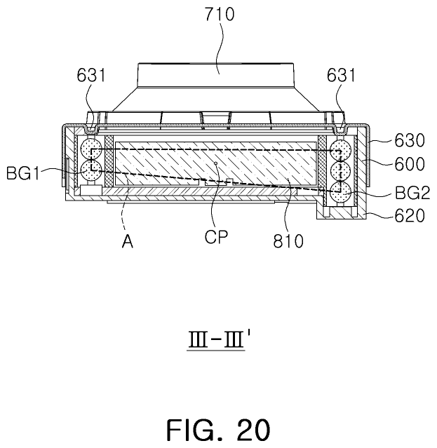

FIG. 16 illustrates a perspective view of the second actuator 20, in accordance with one or more embodiments, FIG. 17 illustrates a schematic exploded perspective view of the second actuator 20, in accordance with one or more embodiments, FIG. 18 illustrates a side view of the carrier, in accordance with one or more embodiments, FIG. 19 illustrates a perspective view of the housing, in accordance with one or more embodiments, and FIG. 20 illustrates a cross-sectional view taken along line III-III′ of FIG. 16, in accordance with one or more embodiments.

Referring to FIG. 17, the second actuator 20, in accordance with one or more embodiments, may include a carrier 730, a housing 600, and a second driving unit 800, and may further include a case 630.

In an example, the carrier 730 may include a hollow portion that penetrates through in the optical axis (Z-axis) direction. The lens barrel 710 may be inserted into the hollow portion of the carrier 730. The lens barrel 710 may be fixedly disposed on the carrier 730 while being inserted into the hollow portion. Accordingly, the lens barrel 710 may move together with the carrier 730 in the optical axis (Z-axis) direction.

In a non-limiting example, the housing 600 may have a rectangular box shape with upper and lower sides thereof being open. The housing 600 may have an internal space, and the carrier 730 may be disposed in the internal space of the housing 600.

The case 630 may be coupled to the housing 600. The case 630 may protect components disposed in the internal space of the housing 600, including the second actuator 20.

Additionally, the case 630 may include a projection 631 (FIG. 20) that projects toward a second ball member B2, which will be described below. The projection 631 may serve as a stopper that regulates a movement range of the second ball member B2 and a buffer member.

In an example, the second driving unit 800 may generate a driving force in the optical axis (Z-axis) direction. Accordingly, the carrier 730 may be moved in the optical axis (Z-axis) direction. Although the one or more examples disclose that the carrier 730 may be moved in the optical axis (Z-axis) direction, this is only an example, and the direction in which the carrier 730 actually moves may not coincide with the optical axis (Z-axis).

The second driving unit 800 may include a third driving magnet 810 and a third driving coil 830. The third driving magnet 810 and the third driving coil 830 may be disposed to face each other in a direction, perpendicular to the optical axis (Z-axis) direction.

In an example, the third driving magnet 810 may be disposed on the carrier 730. For example, the third driving magnet 810 may be disposed on one side surface of the carrier 730.

One surface of the third driving magnet 810 may be magnetized to have both an N-pole and an S-pole. For example, one surface of the third driving magnet 810 may have an N-pole, a neutral region, and an S-pole sequentially disposed in the optical axis (Z-axis) direction. In this example, a first surface of the third driving magnet 810 may be a surface facing the third driving coil 830, which will be described below. Additionally, a second surface of the third driving magnet 810 may also be magnetized to have both an S-pole and an N-pole. For example, the second surface of the third driving magnet 810 may have an S-pole, a neutral region, and an N-pole sequentially disposed in the optical axis (Z-axis) direction.

Additionally, although not illustrated in the drawings, a back yoke (not illustrated) may be disposed between the carrier 730 and the third driving magnet 810. The back yoke may improve the driving force by preventing a leakage of a magnetic flux of the third driving magnet 810.

In an example, the third driving coil 830 may be disposed to face the third driving magnet 810. For example, the third driving coil 830 may be disposed to face the third driving magnet 810 in a direction, perpendicular to the optical axis (Z-axis) direction.

In an example, the third driving coil 830 may be mounted on a second substrate 890 and may be disposed on the housing 600. The second substrate 890 on which the third driving coil 830 is mounted may be disposed on the housing 600 so that the third driving magnet 810 and the third driving coil 830 face each other in a direction, perpendicular to the optical axis (Z-axis) direction.

In an example, the third driving magnet 810 may be a movable member mounted on the carrier 730 to move in the optical axis (Z-axis) direction together with the carrier 730, and the third driving coil 830 may be a fixed member that is fixed to the second substrate 890.

When power is applied to the third driving coil 830, the carrier 730 may be moved in the optical axis (Z-axis) direction due to an electromagnetic force between the third driving magnet 810 and the third driving coil 830. Then, the lens barrel 710 disposed on the carrier 730 may also be moved in the optical axis (Z-axis) direction according to the movement of the carrier 730.

In an example, the second ball member B2 may be disposed between the carrier 730 and the housing 600. The second ball member B2 may include a plurality of ball members arranged along the optical axis (Z-axis) direction. The plurality of ball members may roll in the optical axis (Z-axis) direction when the carrier 730 is moved in the optical axis (Z-axis) direction.

In an example, a third yoke 870 may be disposed on the housing 600. The third yoke 870 may be disposed to face the third driving magnet 810. For example, the third driving coil 830 may be disposed on one surface of the second substrate 890, and the third yoke 870 may be disposed on the other surface of the second substrate 890.

An attractive force may act between the third driving magnet 810 and the third yoke 870. For example, the attractive force may act between the third driving magnet 810 and the third yoke 870 in a direction, perpendicular to the optical axis (Z-axis) direction. Then, due to the attractive force between the third driving magnet 810 and the third yoke 870, the second ball member B2 may be maintained in contact with each of the carrier 730 and the housing 600.

In an example, the carrier 730 and the housing 600 may include guide grooves in their surfaces facing each other in a direction, perpendicular to the optical axis (Z-axis) direction. For example, the carrier 730 may include a third guide groove 731 (g1, g2), and the housing may include a fourth guide groove 610 (FIG. 19).

The second ball member B2 may be disposed between the third guide groove 731 and the fourth guide groove 610. The third guide groove 731 and the fourth guide groove 610 may elongate in the optical axis (Z-axis) direction.

The third guide groove 731 may include a first groove g1 and a second groove g2, and the fourth guide groove 610 may include a third groove g3 and a fourth groove g4. For example, the first groove g1 and the third groove g3, the second groove g2 and the fourth groove g4 may be disposed to face each other in a direction, perpendicular to the optical axis (Z-axis) direction. Additionally, some of the plurality of ball members constituting the second ball member B2 (hereinafter, a first ball group BG1) may be disposed between the first groove g1 and the third groove g3, and the other ones of the plurality of ball members constituting the second ball member B2 (hereinafter, a second ball group BG2) may be disposed between the second groove g2 and the fourth groove g4.

In an example, the first ball group BG1 may be in three-point contact with the first groove g1 and the third groove g3. For example, the first ball group BG1 may be in one-point contact with the first groove g1 and in two-point contact with the third groove g3, or vice versa.

Additionally, the second ball group BG2 may be in four-point contact with the second groove g2 and the fourth groove g4. For example, the second ball group BG2 may be in two-point contact with each of the second groove g2 and the fourth groove g4.

In one or more examples described above, the second groove g2 and the fourth groove g4 may be main guides, and the first groove g1 and the third groove g3 may be auxiliary guides. However, the operation of the first groove g1 and the third groove g3 and the operation of the second groove g2 and the fourth groove g4 are not limited thereto, and may be interchanged.

In an example, the first ball group BG1 and the second ball group BG2 may be spaced apart from each other in a direction, perpendicular to the optical axis (Z-axis). Additionally, as illustrated in FIG. 20, the number of balls included in the first ball group BG1 and the number of balls included in the second ball group BG2 may be different from each other.

Referring to FIG. 20, in an example, the first ball group BG1 may include two balls, and the second ball group BG2 may include three balls. The two balls constituting the first ball group BG1 may have the same diameter, for example, a first diameter. At least some of the three balls constituting the second ball group BG2 may have a different diameter. For example, in the second ball group BG2, the two balls disposed outermost in the optical axis (Z-axis) direction may have a second diameter, and one ball disposed therebetween may have a third diameter. In this example, the second diameter may be substantially the same as the first diameter, and may be larger than the third diameter.

Additionally, as illustrated in FIG. 20, a distance between the centers of the two balls constituting the first ball group BG1 may be different from a distance between the centers of the two balls disposed outermost in the optical axis (Z-axis) direction among the three balls constituting the second ball group BG2. For example, the distance between the centers of the two balls of the first ball member BG1 may be shorter than the distance between the centers of the two balls of the second ball member BG2.

In an example, a center point CP of the attractive force acting between the third driving magnet 810 and the third yoke 870 may be located within a support area A in which contact points between the second ball member B2 and the carrier 730 or the housing 600 are connected to each other. Accordingly, when the carrier 730 is moved in the optical axis (Z-axis) direction, the carrier 730 may be moved in a direction parallel to the optical axis (Z-axis) direction without being tilted. As a result, driving stability can be secured during focusing.

In an example, the first groove g1 and the second groove g2 may have different lengths in the optical axis (Z-axis) direction. For example, the second groove g2 may be formed to be longer than the first groove g1 in the optical axis (Z-axis) direction.

Referring to FIG. 18, the second groove g2 may project from a lower surface of the carrier 730 in the optical axis (Z-axis) direction. For example, a first extension 740 projecting downward in the optical axis (Z-axis) direction may be formed on the lower surface of the carrier 730, and the first extension 740 makes it possible to form the second groove g2 to have a long length.

Similarly, the third groove g3 and the fourth groove g4 may have different lengths in the optical axis (Z-axis) direction, and the fourth groove g4 may be formed to be longer than the third groove g3 in the optical axis (Z-axis) direction.

Referring to FIG. 20, the fourth groove g4 may project from a lower surface of the housing 600 in the optical axis (Z-axis) direction. For example, a second extension 620 projecting downward in the optical axis (Z-axis) direction may be formed on the lower surface of the housing 600, and the second extension 620 makes it possible to form the fourth groove g4 to have a long length.

By forming the second groove g2 and the fourth groove g4, which serve as main guides, to be longer in the optical axis (Z-axis) direction than the first groove g1 and the third groove g3, which serve as auxiliary guides as described above, it is possible to prevent a change in size of the support area A or prevent the center point CP of the attractive force acting between the third driving magnet 810 and the third yoke 870 from being deviated from the support area A, as the second ball member B2 moves in the optical axis (Z-axis) direction.

In an example, the fixed frame 100 and the movable frame 200 of the first actuator 10 may include escape areas to secure spaces as the first extension 740 and the second extension 620 project.

For example, the fixed frame 100 may include a first accommodation hole 140 that penetrates through the fixed frame 100 in the optical axis (Z-axis) direction, and the movable frame 200 may include a second accommodation hole 280 that penetrates through the movable frame 200 in the optical axis (Z-axis) direction. The first accommodation hole 140 and the second accommodation hole 280 may overlap each other in the optical axis (Z-axis) direction.

In an example, when the first actuator 10 and the second actuator 20 are coupled to each other, the first extension 740 and the second extension 620 may be disposed in the first accommodation hole 140 and the second accommodation hole 280. In this example, taking into account that the movable frame 200 is moved on a plane perpendicular to the optical axis (Z-axis), the second accommodation hole 280 may have a larger size than the first extension 740 and the second extension 620 based on the plane perpendicular to the optical axis (Z-axis).

Additionally, although the first extension 740 of the second actuator 20 extending in the optical axis (Z-axis) direction may be formed on the lower surface of the carrier 730 and the second extension 620 of the second actuator 20 extending in the optical axis (Z-axis) direction may be formed on the lower surface of the housing 600, since the first extension 740 and the second extension 620 are disposed in the first actuator 10, it is possible to prevent an increase in height of the camera module 1 in the optical axis (Z-axis) direction.

In an example, the second actuator 20 may include a third position sensor 850 that detects a position of the carrier 730 in the optical axis (Z-axis) direction. In an example, the third position sensor 850 may be mounted on the second substrate 890, and may be disposed on the housing 600 to face the third driving magnet 810. In an example, the third position sensor 850 may be a hall sensor.

In the camera module 1, in accordance with one or more embodiments described above, since optimal image stabilization may be performed by moving the sensor substrate 400, which has a relatively light weight, it is possible to more precisely control a driving force during optical image stabilization. Additionally, the size of the sensor substrate 400 can be reduced in a direction, perpendicular to the optical axis (Z-axis), and therefore, it is possible to achieve a size reduction.

As set forth above, an actuator for optical image stabilization, in accordance with one or more embodiments, and a camera module including the same may precisely control a driving force for optical image stabilization.

Additionally, an actuator for optical image stabilization, in accordance with one or more embodiments, and a camera module including the same can be reduced in size in at least one direction.

While this disclosure includes specific examples, it will be apparent to one of ordinary skill in the art, after an understanding of the disclosure of this application, that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

What is claimed is:

1. An optical image stabilization actuator, comprising:
a sensor substrate on which an image sensor having an imaging surface is disposed;
a movable frame coupled to the sensor substrate, and configured to move in a direction parallel to the imaging surface;
a fixed frame configured to accommodate the sensor substrate and the movable frame; and
a first driving unit disposed on the movable frame and the fixed frame, and configured to provide a driving force to the movable frame,
wherein the sensor substrate comprises:
a movable part coupled to the movable frame;
a fixed part coupled to the fixed frame, and spaced apart from the movable frame in a direction, perpendicular to the imaging surface; and
a connection part connected to the movable part and the fixed part,
wherein the connection part is connected to the movable part in a direction different from a direction in which the connection part is connected to the fixed part.

2. The actuator of claim 1, wherein the connection part comprises:
a first support connected to the fixed part in the direction parallel to the imaging surface;
a second support connected to the movable part in the direction perpendicular to the imaging surface; and
a plurality of bridges, each having a length in the direction parallel to the imaging surface, and configured to connect the first support and the second support to each other.

3. The actuator of claim 2, wherein the first support is spaced apart from the movable part, and the second support is spaced apart from the fixed part.

4. The actuator of claim 2, wherein the first support and the second support are made of a rigid material, and the plurality of bridges are made of a flexible material.

5. The actuator of claim 2, wherein the direction parallel to the imaging surface comprises a first axis direction and a second axis direction, perpendicular to each other, and
the second support is configured to have a longer length than a length of the first support in at least one of the first axis direction and the second axis direction.

6. The actuator of claim 2, wherein the second support comprises a first pad disposed on a surface that faces the movable part in the direction perpendicular to the imaging surface, and
the movable part comprises a second pad on any one surface thereof parallel to the imaging surface.

7. The actuator of claim 6, further comprising a conductive adhesive layer disposed between the movable part and the second support.

8. The actuator of claim 6, wherein the movable part comprises an opening that penetrates therethrough in the direction perpendicular to the imaging surface to expose the first pad.

9. The actuator of claim 1, wherein the direction parallel to the imaging surface comprises a first axis direction and a second axis direction, perpendicular to each other, and
the movable part is configured to have a shorter length than a length of the fixed part in at least one of the first axis direction and the second axis direction.

10. The actuator of claim 1, further comprising:
a first ball member disposed between the movable frame and the fixed frame, and configured to support a movement of the movable frame; and
a plurality of magnetic bodies disposed on the movable frame and the fixed frame respectively, and configured to generate an attractive force in the direction perpendicular to the imaging surface.

11. The actuator of claim 10, wherein the first driving unit comprises:
a first driving magnet and a second driving magnet disposed on the movable frame; and
a first driving coil and a second driving coil disposed on the fixed frame, and configured to face the first driving magnet and the second driving magnet, respectively,
wherein the plurality of magnetic bodies disposed on the movable frame are the first driving magnet and the second driving magnet.

12. The actuator of claim 11, wherein the plurality of magnetic bodies disposed on the fixed frame are a plurality of pulling yokes, and
the plurality of pulling yokes are disposed to face the first driving magnet and the second driving magnet.

13. An optical image stabilization actuator, comprising:
a movable part comprising an image sensor having an imaging surface, and configured to move in a direction parallel to the imaging surface;
a fixed part spaced apart from the movable part in a direction perpendicular to the imaging surface;
a plurality of supports each connected to one of the fixed part and the movable part; and
a plurality of bridges configured to support a movement of the movable part, and configured to connect the plurality of supports to each other.

14. The actuator of claim 13, wherein the plurality of supports comprise:
a first support connected to the fixed part; and
a second support connected to the movable part,
wherein the movable part and the second support are electrically connected to each other.

15. The actuator of claim 13, wherein the direction parallel to the imaging surface comprises a first axis direction and a second axis direction, perpendicular to each other, and
wherein the movable part has a shorter length than a length of the fixed part in at least one of the first axis direction and the second axis direction.

16. A camera module, comprising:
a lens module comprising at least one lens;
a focusing actuator configured to move the lens module in an optical axis direction; and
the optical image stabilization actuator of claim 1.

17. A camera module, comprising:
a sensor substrate on which an image sensor is disposed;
a fixed frame; and
a movable frame, disposed on the fixed frame;
wherein the sensor substrate comprises:
a fixed printed circuit board (PCB), coupled to a lower surface of the fixed frame;
a movable PCB, on which the image sensor is mounted, and configured to move together with the movable frame in a direction perpendicular to an optical axis direction; and
a connection part configured to connect the fixed PCB and the movable PCB to each other;
wherein the movable PCB is configured to overlap the fixed PCB in the optical axis direction.

18. The camera module of claim 17, wherein the movable PCB is configured to have a shorter length in at least one of a first axis direction and a second axis direction perpendicular to the optical axis direction when compared to the fixed PCB.

19. The camera module of claim 17, wherein the connection part comprises a first support configured to connect the connection part to the fixed PCB, and a second support configured to connect the connection part to the movable PCB.
